(19) United States
(12) Patent Application Publication
(10) Pub. No.: US 2022/0171511 A1
(43) Pub. Date: Jun. 2, 2022

(54) DEVICE, METHOD FOR DEVICE, AND STORAGE MEDIUM

(71) Applicant: CANON KABUSHIKI KAISHA, Tokyo (JP)

(72) Inventors: Katsuhiro Inoue, Chiba (JP); Tatsuya Oi, Kanagawa (JP)

(21) Appl. No.: 17/535,412

(22) Filed: Nov. 24, 2021

(30) Foreign Application Priority Data
Nov. 30, 2020 (JP) 2020-197887

(51) Int. Cl. G06F 3/0485; G06F 3/04842; G06F 3/04883; G06T 13/00

(52) U.S. Cl. CPC G06F 3/0485; G06T 13/00; G06F 3/04883; G06F 3/04842

(57) ABSTRACT

When a user touches an object displayed in a partially non-displayed state at an upper end or a lower end of a list display area, a scroll display with animation with respect to a list is automatically executed on the list display area. This ensures that the user recognizes that the list has been scrolled, thereby making it possible to prevent any misrecognition of the object.

### BACKGROUND OF THE DISCLOSURE

### Field of the Disclosure

The aspect of the embodiments relates to a display device, a control method for the display device, and a storage medium.

### Description of the Related Art

In recent years, a touch panel is generally used as a display device in an information processing apparatus such as a computer. In such information processing apparatus, an arbitrary object is displayed as a list on a screen of the touch panel, and executing a flick operation on the list scrolls the list.

In the touch panel where such flick operation is executed, if the number of objects displayed as the list is large, a user has to look for a desired object while scrolling the list to display the desired object in a position where the object can be easily seen.

As a solution to such an issue, Japanese Patent Application Laid-Open No. 8-95732 discusses a technique for moving a selected item (object) to an easily viewable position on a list. In the Japanese Patent Application Laid-Open No. 8-95732, the list is automatically scrolled so that the selected item is displayed in the center of the list. This means that even if the selected item is at an upper end or a lower end of the list, the selected item will be displayed in an easily viewable position without the need for scrolling the list.

However, according to the above Japanese Patent Application Laid-Open No. 8-95732, a user does not always notice that the list has been scrolled because the scrolling of the list is completed in an instant. In particular, in a case where the appearance of each item is very similar, the above possibility is even higher because the appearance of the entire list changes little before and after the scrolling. As a result, there is a risk that the user may select a wrong item.

### SUMMARY OF THE DISCLOSURE

According to an aspect of the disclosure, a device includes one or more memories that store instructions, and one or more processors configured to execute the stored instructions to: display a plurality of objects in a display area, and execute a scroll display of a screen, in a case where a selection instruction is received from a user for an object that cannot be fully displayed in the display area and includes a non-displayed portion, so that the non-displayed portion of the selected object is displayed, wherein the scroll display is executed at a speed at which the user can recognize how a scrolling operation is executed.

Further features of the disclosure will become apparent from the following description of exemplary embodiments with reference to the attached drawings.

### BRIEF DESCRIPTION OF THE DRAWINGS

FIG. 1 is a diagram illustrating a hardware configuration of an image processing apparatus.

FIG. 2 is an example of an e-mail sending screen.

FIGS. 3A and 3B are diagrams each illustrating an example of a scroll display with animation.

FIG. 4 is a flowchart describing a process in a case of the scroll display with animation.

FIG. 5 is a flowchart describing a process in the case of the scroll display with animation.

FIG. 6 is a diagram describing an example of a transition of a screen.

FIG. 7 is a flowchart describing a process in the case of the scroll display with animation.

FIGS. 8A and 8B are diagrams each illustrating a list movement amount in the case of the scroll display with animation.

### DESCRIPTION OF THE EMBODIMENTS

### Hardware Configuration

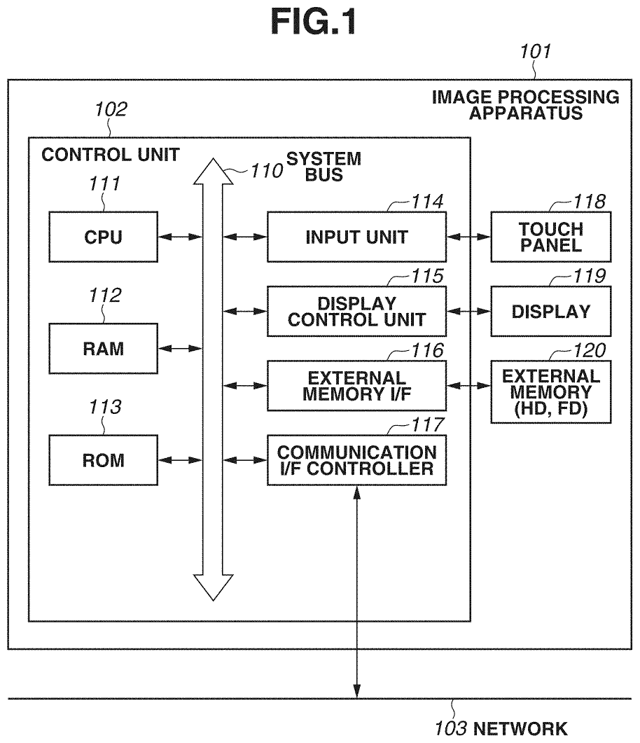

FIG. 1 is a diagram illustrating a hardware configuration of an information processing apparatus provided with a display device according to a first exemplary embodiment.

In the present exemplary embodiment, an image processing apparatus 101 such as a printer, a scanner, a fax machine, a copying machine, and a multi-function peripheral is used as an example of the information processing apparatus provided with the display device.

In a control unit 102 of FIG. 1, a central processing unit (CPU) 111, a random access memory (RAM) 112, a read only memory (ROM) 113, an input unit 114, a display control unit 115, an external memory interface (I/F) 116, and a communication I/F controller 117 are connected to a system bus 110. A touch panel 118, a display 119, and an external memory 120 are also connected. Each of the parts connected to the system bus 110 is configured to be able to exchange data with each other via the system bus 110.

According to a program stored in the ROM 113, for example, the CPU 111 uses the RAM 112 as a work memory and controls each part of the image processing apparatus 101. The program for the operation of the CPU 111 is not limited to the one stored in the ROM 113, but can also be stored in advance in the external memory (hard disk, etc.) 120. The RAM 112 is a volatile memory, and is used as a main memory of the CPU 111 and a temporary storage area such as work area. The ROM 113 is a non-volatile memory and image data or other data, and various programs for operating the CPU 111 are stored in respective predetermined areas.

The input unit 114 receives a user operation, generates a control signal that corresponds to the user operation and supplies the control signal to the CPU 111. As an input device for receiving the user operation, the input unit 114 includes a character information input device (not illustrated) such as a keyboard, and a pointing device such as a mouse (not illustrated) and the touch panel 118. The touch panel 118 is an input device that detects a position touched by the user on an input unit configured, for example, as a plane, and outputs coordinate information that corresponds to the position. Based on the control signal generated and supplied by the input unit 114 according to the user operation made to the input device, the CPU 111 controls each part of the image processing apparatus 101 according to a program. This allows the user to cause the image processing apparatus 101 to execute an operation that accords to the user operation.

The display control unit 115 outputs a display signal to the display 119 for displaying the image. For example, a display control signal generated by the CPU 111 according to the program is supplied to the display control unit 115. The display control unit 115 generates the display signal based on the display control signal and outputs the display signal to the display 119. Based on the display control signal generated by the CPU 111, the display control unit 115 causes the display 119 to display a graphical user interface (GUI) screen included in a GUI.

The touch panel 118 is integrally configured with the display 119. For example, the touch panel 118 is configured so that light transmittance does not interfere with a display operation of the display 119, and is mounted on an upper layer of a display surface of the display 119. Then, an input coordinate on the touch panel 118 is associated with a display coordinate on the display 119. This makes it possible to configure the GUI as if the user can directly operate the screen displayed on the display 119.

The external memory 120 such as a hard disk, a floppy disk®, a compact disk (CD), a digital video disk (DVD), and a memory card can be mounted to the external memory I/F 116. Based on the control of the CPU 111, the external memory I/F 116 reads data from and writes data to the external memory 120, which has been mounted. Based on the control of the CPU 111, the communication I/F controller 117 executes a communication to a network 103 such as a local area network (LAN), the Internet, a wired network, and a wireless network.

The CPU 111 can distinguish and detect the user's operation on the touch panel 118 as follows: a finger or a pen touches down on the touch panel (hereinafter referred to as “touch down”); finger or the pen is touching on the touch panel (hereinafter referred to as “touch on”); the finger or the pen is moving while touching on the touch panel (hereinafter referred to as “move”); the finger or the pen that has been touching the touch panel is released (hereinafter referred to as “touch up”); nothing touches on the touch panel (hereinafter referred to as “touch off”), etc.

These operations and a positional coordinate of the finger or pen touching on the touch panel 118 are notified to the CPU 111 through the system bus 110, and, based on the notified information, the CPU 111 determines what operation has been executed on the touch panel 118.

Concerning the move, a moving direction of the finger or pen moving on the touch panel 118 can also be determined for each vertical component and horizontal component on the touch panel, based on the change in the positional coordinate. When the touch up is made on the touch panel 118 after a certain move from the touch down, a stroke is deemed to have been drawn. An operation of quickly drawing the stroke is called “flick”. The flick is an operation in which, with the finger being touched on the touch panel 118, the finger is quickly moved for a certain distance, and then the finger is released as it is. In other words, it is an operation of tracing quickly performed on the touch panel 118 as if a hitting operation were made by the finger. In a case where the move by a predetermined distance or more and at a predetermined speed or more is detected, and the touch up is detected as it is, the CPU 111 determines that the flick has been executed. In a case where the move of the predetermined distance or more is detected and the touch on is detected as it is, CPU 111 determines that a drag has been executed. The touch panel 118 can use any of various touch panel methods, such as a resistive film method, a capacitance method, a surface acoustic wave method, an infrared method, an electromagnetic induction method, an image recognition method, and an optical sensor method.

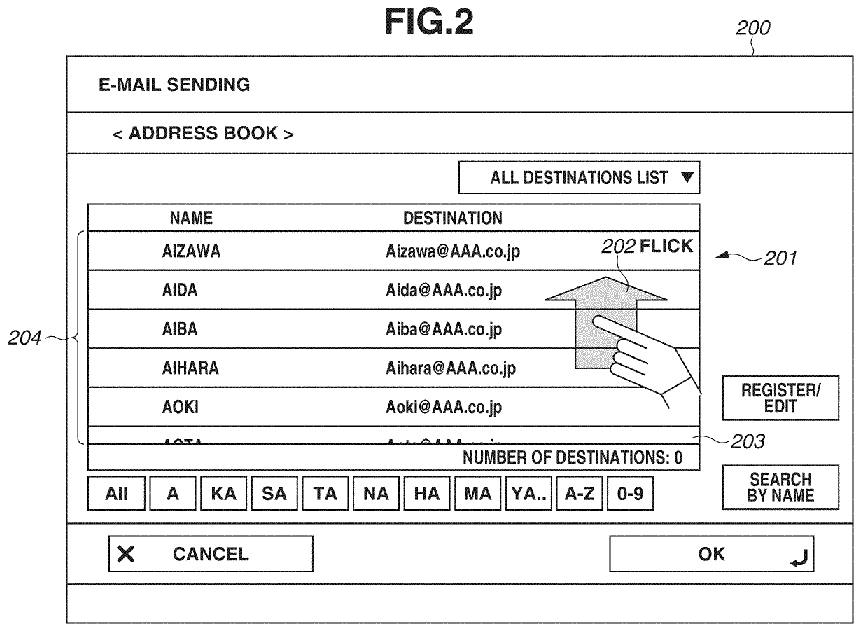

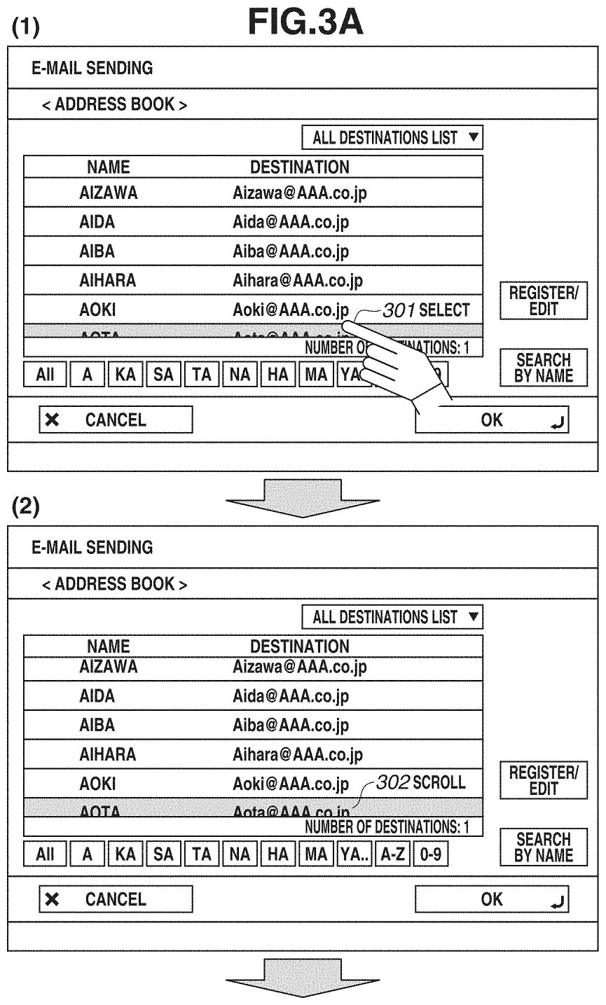

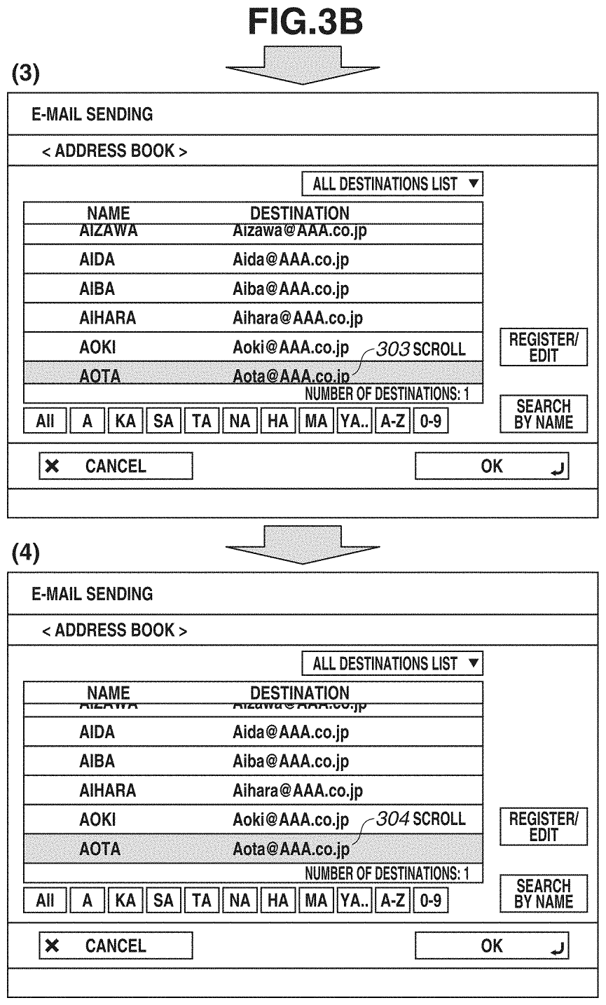

Referring to FIGS. 2 and 3, the display operation on the display 119 of the image processing apparatus 101 will be described.

FIG. 2 is an example of an e-mail sending screen 200 for selecting an address to be a destination for e-mail sending when an e-mail sending function, which is one of the functions for data sending provided by the image processing apparatus 101, is used. Data of an address book is stored in the external memory 120 of the image processing apparatus 101. As illustrated in FIG. 2, when the number of pieces of destination data included in the address book is large, an address list 201 including the entirety of a plurality of destinations does not fit within a list display area 204 of the e-mail sending screen 200. In such a case, the user is to scroll the address list 201 in the list display area 204 in order to display, in the list display area 204, a desired destination that is not displayed.

FIG. 2 illustrates an example of the user flicking any position of the list display area 204 in which the address list is displayed on the display 119 (see a reference numeral 202). As illustrated in FIG. 2, when the user executes an upward flick operation, the displayed address list 201 scrolls upward.

Depending on the display position of the address list 201, the destination displayed at the upper or lower end of the list display area 204 may be displayed in a partially non-displayed state (hereinafter also referred to as the “partially non-displayed state”). In the example of FIG. 2, a destination displayed at the lower end of the list display area 204 is displayed in the partially non-displayed state (see a reference numeral 203).

In the present exemplary embodiment, when the destination displayed in the partially non-displayed state at the upper or lower end of the list display area 204 of the e-mail sending screen 200 is touched, a scroll display with animation is executed so that the display position of the destination fits within the list display area 204. Here, the destination being scroll-displayed with animation means that the destination is scroll-displayed in the list display area in a state visible to the user.

FIGS. 3A and 3B are diagrams each illustrating an example of the scroll display with animation, which is executed in a case where a destination that is in the partially non-displayed state at the upper or lower end of the list display area is touched down (hereinafter referred to as “pressed”).

First, it is assumed that the user presses a destination that is displayed in the partially non-displayed state at the lower end of the list display area as illustrated in FIG. 3A(1). Then, as illustrated in FIG. 3A(2), the address list is scrolled upward by 1/3 of the partially non-displayed amount (non-displayed portion) of the touched destination. Further, as illustrated in FIG. 3B(3) and FIG. 3B(4), the address list is scrolled upward by ⅓ of the partially non-displayed amount until the whole of the pressed destination is so displayed as to fit within the list display area. Thereafter, as illustrated in FIG. 3B(4), the whole of the destination that had been displayed in the partially non-displayed state is so displayed as to fit within the list display area. When the display becomes this state, the user can select the destination, which was in the partially non-displayed state, by pressing it. In the present exemplary embodiment, such a display method realizes the scroll display with animation of the address list.

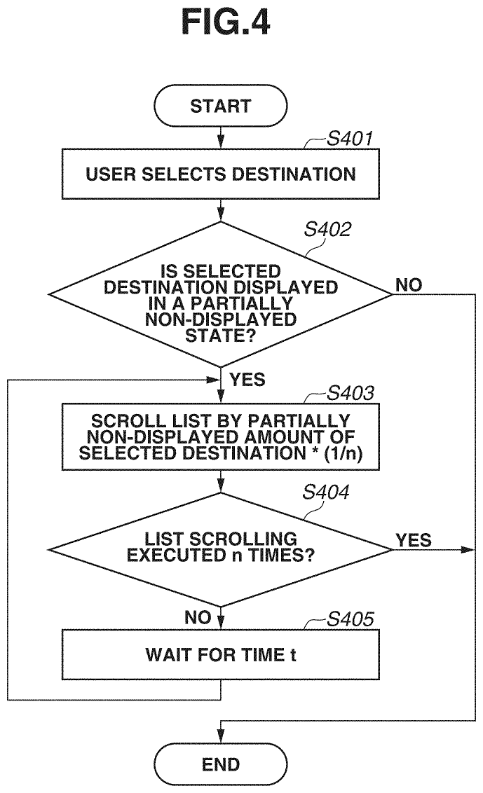

Referring to FIG. 4, an operation of the scroll display with animation in the image processing apparatus 101 of the present exemplary embodiment will be described. FIG. 4 is a flowchart illustrating a process executed in the image processing apparatus 101 when the address list 201 as illustrated in FIG. 2 is displayed on the display 119. Each of the processes of FIG. 4 is executed by the CPU 111 executing the program stored in the ROM 113 or the external memory 120.

In step S401, with the user operating the touch panel 118, the CPU 111 detects that one destination has been pressed from the address list 201.

In step S402, the CPU 111 determines whether the destination pressed in step S401 is displayed in a state where the destination is partially non-displayed at the upper or lower end of the list display area 204.

Specifically, in a case where a coordinate of the upper side of the pressed destination is outside the list display area 204, it is determined that the destination is displayed in the partially non-displayed state at the upper end of the list display area 204. In a case where a coordinate of the lower side of the destination is outside the list display area 204, it is determined that the destination is displayed in the partially non-displayed state at the lower end of the list display area 204.

As a result of the determination of step S402, in a case where the pressed destination is displayed in the partially non-displayed state (YES in step S402), the operation proceeds to step S403. Meanwhile, in a case where, as a result of the determination of step S402, the pressed destination is not displayed in the partially non-displayed state (NO in step S402), it is determined that the above destination is displayed so that the whole thereof fits within the list display area 204, and the process of FIG. 4 ends.

In step S403, as the number of frames n, which is a parameter indicating with how many divisions the animation is expressed, the CPU 111 scrolls the address list 201 by 1/n of the partially non-displayed amount of the pressed destination and displays the address list 201 on the list display area 204.

In step S404, the CPU 111 determines whether the scrolling in step S403 has been executed n times. In a case where, as a result of the determination of step S404, the scrolling has not yet been executed n times (NO in step S404), the operation proceeds to step S405. In step S405, the CPU 111 stops the process until a frame rate t set as a parameter has elapsed. That is, the smaller the value oft becomes, the faster the animation goes. In the present exemplary embodiment, the number of frames n and the frame rate t can be set by the user on the touch panel 118 or the like in a manner to ensure that the animation is visible.

In this way, waiting for the next scrolling until the time t elapses can provide an interval until the scrolling in step S403 is displayed on the display 119 for the second and subsequent times, and can realize an animation that is securely visible to the user.

As a result of the determination of step S404, in a case where the scrolling has been executed n times (YES in step S404), it is determined that the pressed destination has been displayed in a manner to fit within the list display area 204, and the process of FIG. 4 ends.

In this way, in a case where the destination that is displayed in the partially non-displayed state is pressed, the image processing apparatus 101 according to the present exemplary embodiment executes the scrolling with animation ensuring that the user can see the animation, thereby displaying the whole of the destination in a manner to fit within the screen.

With this, even if the user accidentally presses the destination displayed in the partially non-displayed state, the address list scrolls at a slow speed in a visible manner, so that the user can be sure to recognize that the wrong destination was pressed.

In the above exemplary embodiment, the address list included in the address book is described as the example of the list of the to-be-displayed objects, but the disclosure is not limited to the address list and is applicable to a list of various objects scrollable on the display.

In addition, in the above exemplary embodiment, when the destination displayed in the partially non-displayed state is pressed, the scrolling with the minimum movement amount is executed so that the destination fits within the screen, but the disclosure is not limited thereto. That is, when an arbitrary object is pressed, scrolling with an arbitrary movement amount can be executed. Further, the direction of the scrolling can be applied not only to an up and down direction but also in any direction.

In the above exemplary embodiment, a setting unit for setting the parameters n and t by the user can be provided on the GUI screen displayed on the display 119 or on any input device connected to the input unit 114.

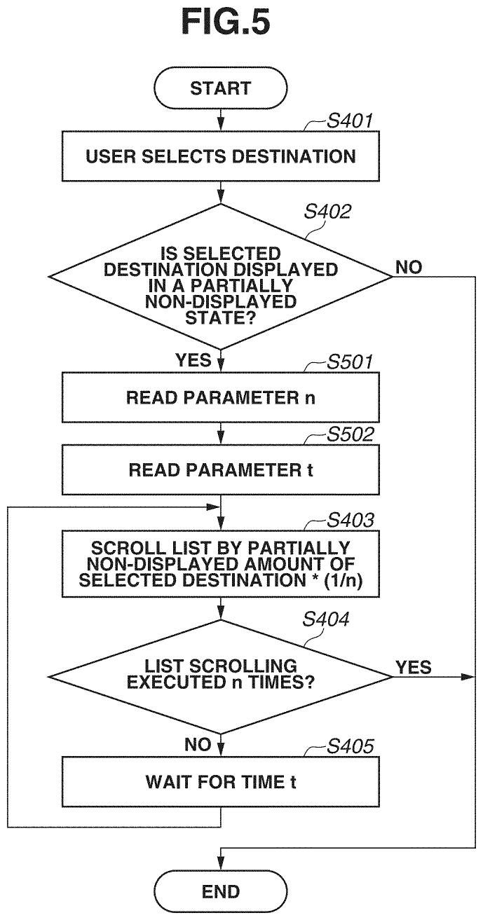

FIG. 5 is a flowchart illustrating an operation of the image processing apparatus 101 in a case in which the above setting unit for setting parameters is provided. Each of the processes of FIG. 5 is processed by the CPU 111 executing the program stored in the ROM 113 or the external memory 120. Since the basic processes are the same as those in in FIG. 4, only the differences will be mainly described.

Step S401 and step S402 are the same as those in the flowchart in FIG. 4.

As a result of the determination of step S402, in a case where the pressed destination is displayed in the partially non-displayed state (YES in step S402), the operation proceeds to step S501.

In step S501, the CPU 111 reads the parameter n set by the user with the setting unit. Then, in step S502, the CPU 111 reads the parameter t set by the user with the setting unit.

Then, in step S403 to step S405, the CPU 111, using the read parameters n and t, executes a process to execute the scroll display with animation.

In the first exemplary embodiment described above, the example has been illustrated in which, when the user presses the object displayed, on the screen, in the partially non-displayed state, the object is caused to be scrolled at a slow speed visible to the user, and then the object can be selected. However, in addition to making the object selectable by pressing the object, there can be another case such as transitioning to the next screen.

Then, a second exemplary embodiment describes an example in which, in a case where the object displayed in the partially non-displayed state is pressed, the object is scrolled at a slow speed, and then a transition is made to the next screen. Since the hardware configuration of the display device is the same as that of the first exemplary embodiment, the description thereof will be omitted.

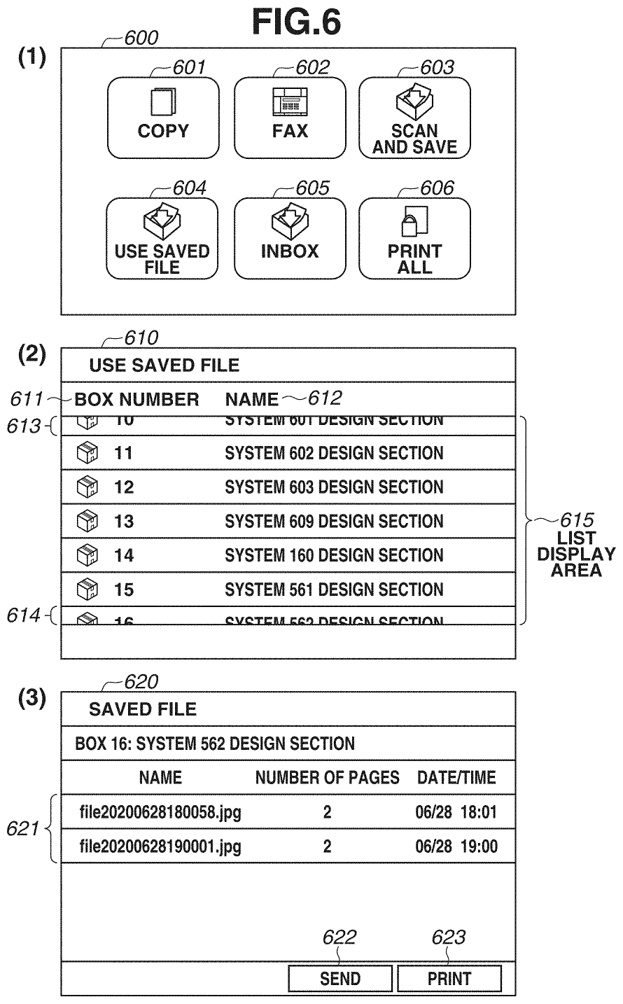

Referring to FIG. 6, the transition of a screen in a case where a use saved file button is pressed on the screen of the image processing apparatus 101, which is common to the first exemplary embodiment, will be described.

FIG. 6(1) illustrates an example of an application selection screen 600, which is an initial screen of the image processing apparatus 101. The application selection screen 600 displays each of the following application buttons: a copy button 601, a fax button 602, a scan and save button 603, a use saved file button 604, an inbox button 605, and a print all button 606. Pressing each of the application buttons will display a usage screen for using the function of the corresponding application. Although the present exemplary embodiment will describe an example using an application of “use saved file”, any other application can be executed in the same way.

FIG. 6(2) illustrates an example of a use saved file screen 610. Pressing the use saved file button 604 in the application selection screen 600 illustrated in FIG. 6(1) displays the use saved file screen 610.

In the use saved file screen 610, a box including a box number 611 and a name 612 is displayed as each line in a list display area 615. A line 613 indicates a box that is displayed in the partially non-displayed state at an upper end of the list display area 615. In addition, a line 614 indicates a box that is displayed in the partially non-displayed state at a lower end of the list display area 615.

By selecting any box in the list display area 615, the user can transition the use saved file screen 610 to a saved file screen 620, which displays a document list corresponding to the selected box.

FIG. 6(3) illustrates an example of the saved file screen 620 for a box 16. The saved file screen 620 illustrated in FIG. 6(3) is a screen that is displayed when the line 614 displayed in the partially non-displayed state in the use saved file screen 610 illustrated in FIG. 6(2) is pressed.

On the saved file screen 620, selecting a saved file 621 and pressing a Send button 622 or a Print button 623 can send or print the selected file.

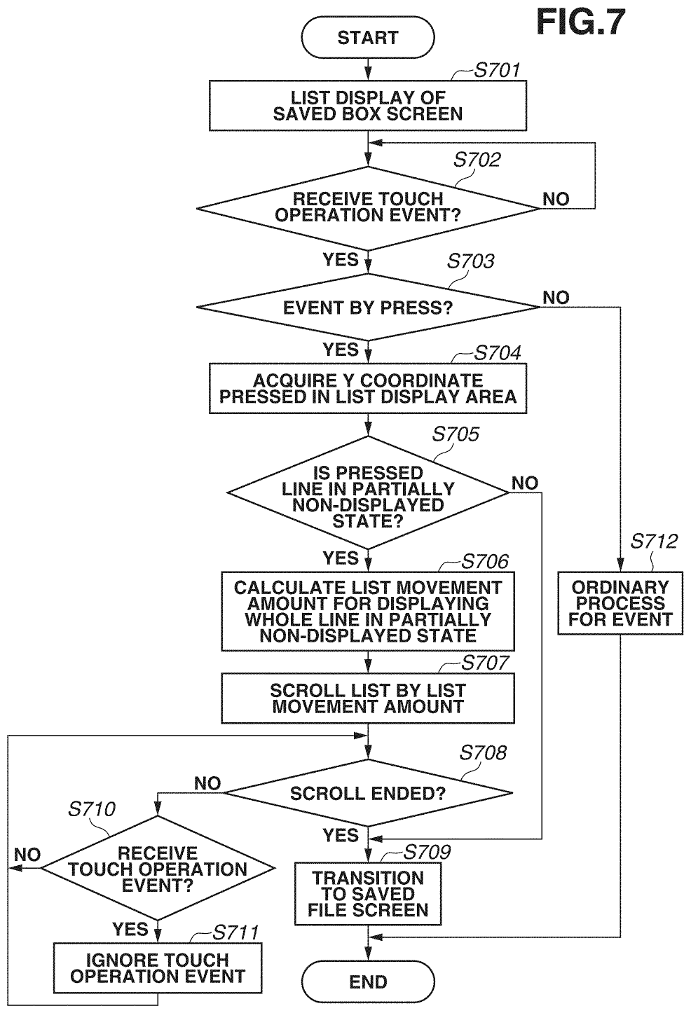

Using the flowchart of FIG. 7, a process for executing the transition from the application selection screen 600, which is the initial screen, to the saved file screen 620 via the use saved file screen 610 will be described. Each of the processes of FIG. 7 is executed by the CPU 111 executing the program stored in the ROM 113 or the external memory 120.

Detecting that the user has pressed the use saved file button 604 on the touch panel 118 from the application selection screen 600, which is the initial screen, the CPU 111, in step S701, receives a control signal from the input unit 114 and sends the display control signal to the display control unit 115 based on the control signal. Then, the display control unit 115 generates a display signal based on the received display control signal and outputs the display signal to the display 119, thereby displaying the use saved file screen 610 on the display 119.

In step S702, the CPU 111 receives a signal sent from the input unit 114 and determines whether a touch is made in the list display area 615 of the use saved file screen 610 on the touch panel 118.

In a case where a touch is made in the list display area 615 (YES in step S702), the operation proceeds to step S703. In a case where no touch is made (NO in step S702), the process returns to step S702.

In step S703, the CPU 111 determines whether the aforementioned touch is a press. In a case of the press (YES in step S703), the operation proceeds to step S704. In a case of not the press (NO in step S703), it is determined to be a drag operation, a flick operation, etc., and the operation proceeds to step S712.

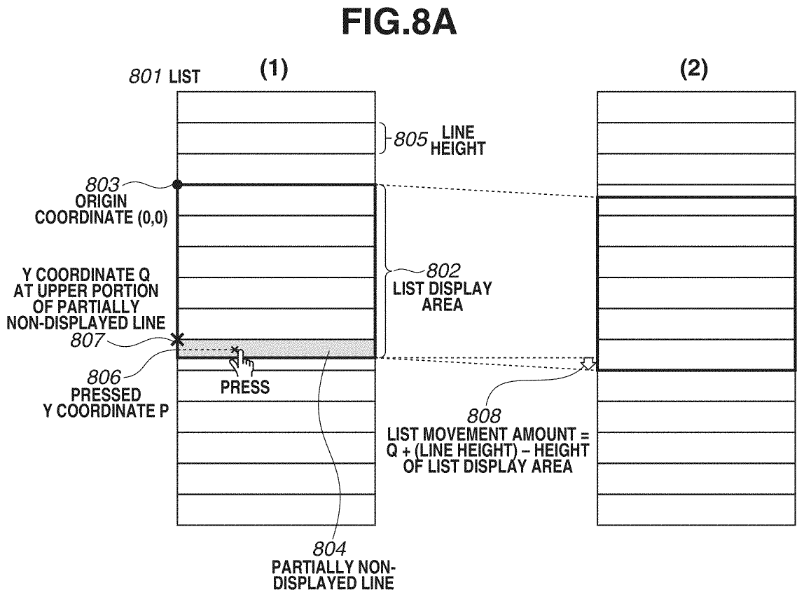

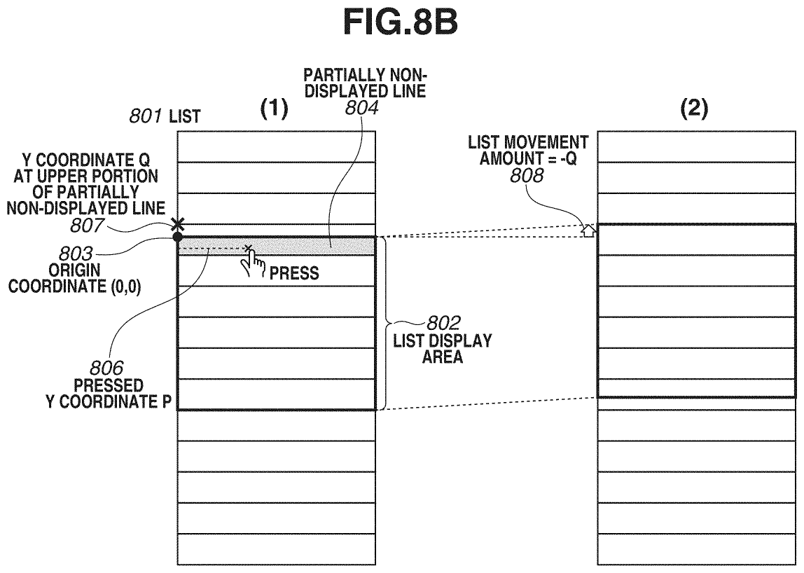

In step S704, the CPU 111 acquires a Y coordinate P (see 806 in FIG. 8) of the position pressed by the user in the list display area 615.

In step S705, the CPU 111 identifies the pressed line from the Y coordinate P acquired in step S704 and determines whether the pressed line is displayed in the partially non-displayed state. Any specific determination method is described below with reference to FIG. 8.

In a case where the pressed line is displayed in the partially non-displayed state (YES in step S705), the operation proceeds to step S706. In a case where the pressed line is not displayed in the partially non-displayed state (NO in step S705), the operation proceeds to step S709.

In step S706, the CPU 111 calculates a list movement amount. Any specific determination method for calculating the list movement amount is also described below with reference to FIG. 8.

In step S707, the CPU 111 sends a signal to the display control unit 115 to scroll the entire list by the list movement amount calculated in step S706. The display control unit 115 generates a display signal based thereon and sends the display signal to the display 119.

In step S708, the CPU 111 determines whether the scrolling of the list in step S707 has ended.

In a case where the scrolling has ended (YES in step S708), the operation proceeds to step S709. Meanwhile, in a case where the scrolling has not yet ended (NO in step S708), the operation proceeds to step S710.

In step S709, the CPU 111 sends the display control signal to the display control unit 115. The display control unit 115 generates a display signal based thereon and sends the display signal to the display 119. Then, the CPU 111 displays the saved file screen 620 on the display 119.

In step S710, the CPU 111 receives the signal sent from the input unit 114, and determines whether the touch is made in the list display area 615.

In a case where the touch is made in the list display area 615 (YES in step S710), the operation proceeds to step S711. Meanwhile, in a case where the touch is not made (NO in step S710), the operation returns to step S708.

In step S711, the CPU 111 does not execute any process for the touch operation, and returns to step S708.

In step S703, in a case where it is determined that the touch made in step S702 is not the press (NO in step S703), in step S712, the CPU 111 executes a process that corresponds to the touch. That is, in a case where it is determined to be the drag operation, a display control signal for the drag operation is sent to the display control unit 115. In a case where it is determined to be the flick operation, a display control signal for the flick operation is sent to the display control unit 115.

Referring to FIGS. 8A and 8B, a method of determining whether the line pressed in step S705 of the flowchart of FIG. 7 is in the partially non-displayed state and a method of calculating the list movement amount for displaying, in the list display area, the whole of the line in the partially non-displayed state in step S706 will be described.

FIG. 8A(1) is an image diagram illustrating an example of a case in which there is a line 804 displayed in the partially non-displayed state (partially non-displayed line) at a lower end of the list display area. FIG. 8B(1) is an image diagram illustrating an example of a case in which there is the partially non-displayed line 804 at an upper end of the list display area.

FIG. 8A(2) is an image diagram illustrating a state in which the scrolling ends after the user presses the partially non-displayed line 804 in the state of FIG. 8A(1). FIG. 8B(2) is an image diagram illustrating a state in which the scrolling ends after the user presses the partially non-displayed line 804 in the state of FIG. 8B(1).

FIGS. 8A and 8B each illustrate an object list 801. The examples in FIGS. 8A and 8B illustrate that there are 14 objects respectively. There is illustrated a list display area 802 capable of displaying the object on the touch panel 118. There is illustrated an origin coordinate 803 of the list display area 802. There is illustrated the partially non-displayed line 804 at the upper end or lower end of the list display area 802. There is illustrated a single line height 805. There is illustrated a coordinate 806 illustrating the Y coordinate P of the position where the user pressed. There is illustrated a coordinate 807 illustrating a Y coordinate Q at the upper portion of the line containing the Y coordinate P of the position where the user pressed.

As illustrated in FIG. 8A(1), with the pressed line (the ninth object) on the lower end side of the list display area 802, in a case where a coordinate of a value obtained by adding the line height 805 to the Y coordinate Q in the upper portion of the pressed line is outside the list display area 802, it is determined that the pressed line is a partially non-displayed line. In this case, a list movement amount 808 required to display the whole of the ninth object, which is the partially non-displayed line, is “Q+(line height)−(height of list display area)”.

When the entire list is scrolled upward by the amount of this list movement amount 808, as illustrated in FIG. 8A(2), the line (the ninth object) pressed in the partially non-displayed state will be entirely displayed in the list display area 802.

Also, as illustrated in FIG. 8B (1), with the pressed line (the fourth object) on the upper end side of the list display area 802, in a case where the Y coordinate Q at the upper portion of the pressed line is smaller than 0, it is determined that the pressed line is a partially non-displayed line. In this case, the list movement amount 808 required to display the whole of the fourth object, which is the partially non-displayed line, is “−Q”.

When the entire list is scrolled downward by the amount of this list movement amount 808, as illustrated in FIG. 8B(2), the line (the fourth object) pressed in the partially non-displayed state will be entirely displayed in the list display area 802.

The image processing apparatus 101 of the disclosure can be provided with various functions. For example, not limited to a printer, a scanner, a fax machine, a copying machine, and a multi-function peripheral, the image processing apparatus 101 of the disclosure can also be provided with functions such as a personal computer, a personal digital assistant (PDA), a mobile phone terminal, a camera, a video camera, and other image viewers.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-197887, filed Nov. 30, 2020, which is hereby incorporated by reference herein in its entirety.

What is claimed is:

1. A device, comprising:
one or more memories that store instructions; and
one or more processors configured to execute the stored instructions to:
display a plurality of objects in a display area; and
execute a scroll display of a screen, in a case where a selection instruction is received from a user for an object that cannot be fully displayed in the display area and includes a non-displayed portion, so that the non-displayed portion of the selected object is displayed,
wherein the scroll display is executed at a speed at which the user can recognize how a scrolling operation is executed.

2. The device according to claim 1, wherein the scroll display is a display with animation.

3. The device according to claim 1, wherein, when the scroll display is executed, the plurality of objects displayed in the display area is scrolled.

4. The device according to claim 1, wherein the scroll display is a scroll display with animation including a predetermined number of frames and a predetermined frame rate.

5. The device according to claim 4, wherein the number of frames and the frame rate are settable.

6. The device according to claim 1, wherein the device is a formation device including at least one of a print function, a scan function, and a fax function.

7. The device according to claim 6, wherein the plurality of objects displayed in the display area is objects for which a destination of data is selected.

8. The device according to claim 1, wherein, after the scroll display of the screen is executed to display the non-displayed portion of the selected object, the screen transitions to a screen corresponding to the selected object.

9. The device according to claim 1,
wherein, with the number of frames defined as n, the scroll display is executed by repeating n times the scrolling operation of 1/n of the non-displayed portion, and
wherein the number of frames is greater than a predetermined value.

10. A method comprising:
displaying a plurality of objects in a display area; and
executing a scroll display of a screen, in a case where a selection instruction is received from a user for an object that cannot be fully displayed in the display area and includes a non-displayed portion, so that the non-displayed portion of the selected object is displayed,
wherein the scroll display is executed at a speed at which the user can recognize how a scrolling operation is executed.

11. The method according to claim 10, wherein the scroll display is a display with animation.

12. The method according to claim 10, wherein, when the scroll display is executed, the plurality of objects displayed in the display area is scrolled.

13. The method according to claim 10, wherein the scroll display is a scroll display with animation including a predetermined number of frames and a predetermined frame rate.

14. The method according to claim 10,
wherein, with the number of frames defined as n, the scroll display is executed by repeating n times the scrolling operation of 1/n of the non-displayed portion, and
wherein the number of frames is greater than a predetermined value.

15. A non-transitory computer-readable storage medium storing a program to cause a computer to perform a method, the method comprising:
displaying a plurality of objects in a display area; and
executing a scroll display of a screen, in a case where a selection instruction is received from a user for an object that cannot be fully displayed in the display area and includes a non-displayed portion, so that the non-displayed portion of the selected object is displayed,
wherein the scroll display is executed at a speed at which the user can recognize how a scrolling operation is executed.

16. The non-transitory computer-readable storage medium according to claim 15, wherein the scroll display is a display with animation.

17. The non-transitory computer-readable storage medium according to claim 15, wherein, when the scroll display is executed, the plurality of objects displayed in the display area is scrolled.

18. The non-transitory computer-readable storage medium according to claim 15, wherein the scroll display is a scroll display with animation including a predetermined number of frames and a predetermined frame rate.

19. The non-transitory computer-readable storage medium according to claim 15,
wherein, with the number of frames defined as n, the scroll display is executed by repeating n times the scrolling operation of 1/n of the non-displayed portion, and
wherein the number of frames is greater than a predetermined value.
